(19) United States
(12) Patent Application Publication
(10) Pub. No.: US 2009/0036207 A1
(43) Pub. Date: Feb. 5, 2009

(54) MULTI-DISPLAY GAMING MACHINE

(75) Inventor: Arden Yang, Rosemead, CA (US)

Correspondence Address: BLISS MCGLYNN, P.C., 2075 WEST BIG BEAVER ROAD, SUITE 600, TROY, MI, 48084, US

(73) Assignee: ASTRO CORP., San-Chung City (TW)

(21) Appl. No.: 12/141,185

(22) Filed: Jun. 18, 2008

(30) Foreign Application Priority Data
Aug. 2, 2007 (TW) 096212695

(51) Int. Cl. A63F 13/00

(52) U.S. Cl. 463/31

(57) ABSTRACT

A multi-display gaming machine includes a housing, a plurality of display devices mounted to the housing, an input device operable for generating control instructions, and a processing device disposed inside the housing, coupled to the display devices and the input device, and loaded with a plurality of gaming programs. The processing device is responsive to the control instructions from the input device for simultaneously executing at least two of the gaming programs, and for outputting gaming screen contents resulting from execution of the gaming programs to respective ones of the display devices for viewing by a player.

### CROSS-REFERENCE TO RELATED APPLICATION

This application claims priority of Taiwanese application no. 096212695, filed on Aug. 2, 2007.

### BACKGROUND OF THE INVENTION

1. Field of the Invention

This invention relates to a gaming machine, more particularly to a gaming machine having multiple displays.

2. Description of the Related Art

Referring to FIG. 1, a conventional gaming machine 1 includes a single display device 11 on which gaming screens, game-related information, and scores must all be displayed. Consequently, the aforementioned content is altered to share the limited display area in such a way that it is difficult to read. Moreover, the conventional gaming machine does not provide the player an option of playing two different games simultaneously.

### SUMMARY OF THE INVENTION

Therefore, an object of the present invention is to provide a gaming machine that is capable of overcoming the aforementioned drawbacks of the prior art.

According to the present invention, there is provided a multi-display gaming machine comprising a housing, a plurality of display devices mounted to the housing, an input device operable for generating control instructions, and a processing device disposed inside the housing, coupled to the display devices and the input device, and loaded with a plurality of gaming programs. The processing device is responsive to the control instructions from the input device for simultaneously executing at least two of the gaming programs, and for outputting gaming screen contents resulting from execution of the gaming programs to respective ones of the display devices for viewing by a player.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional gaming machine;

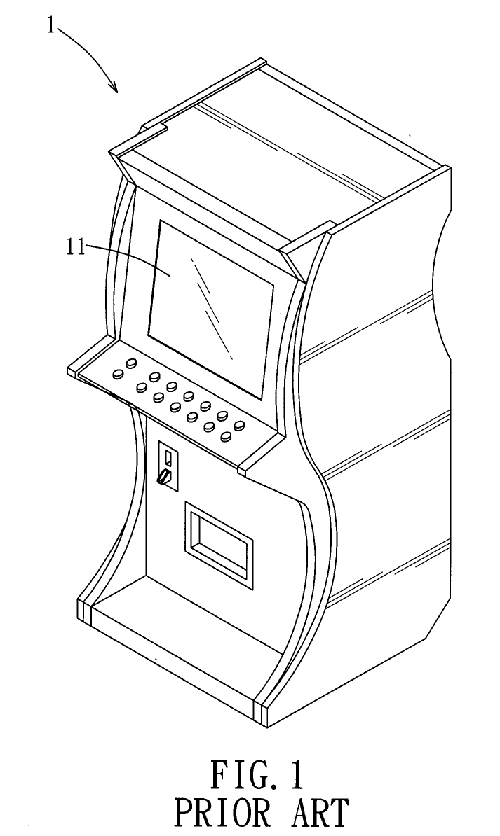

FIG. 2 is a perspective view of a preferred embodiment of a multi-display gaming machine according to the present invention;

FIG. 3 is a schematic view of the multi-display gaming machine of FIG. 2; and

FIG. 4 is a schematic circuit block diagram of a processing device of the preferred embodiment.

### DETAILED DESCRIPTION OF THE PREFERRED EMBODIMENT

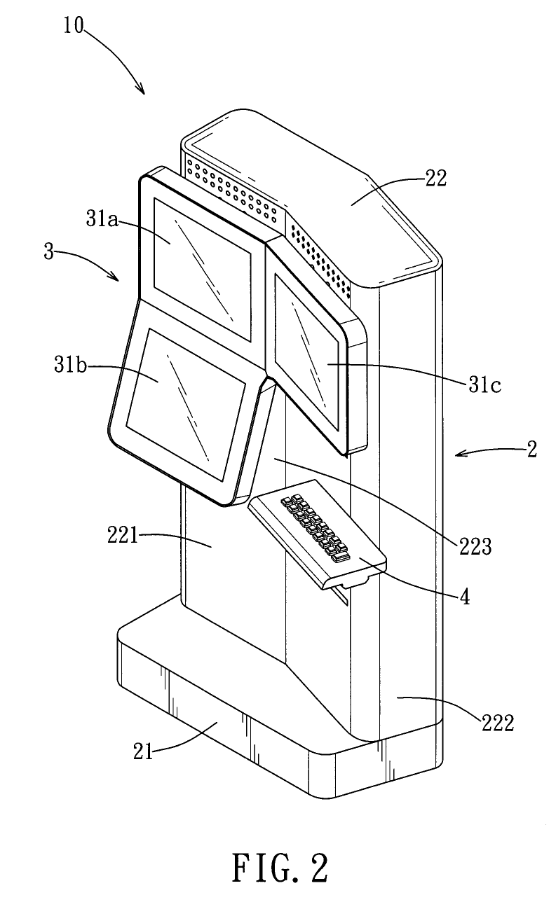

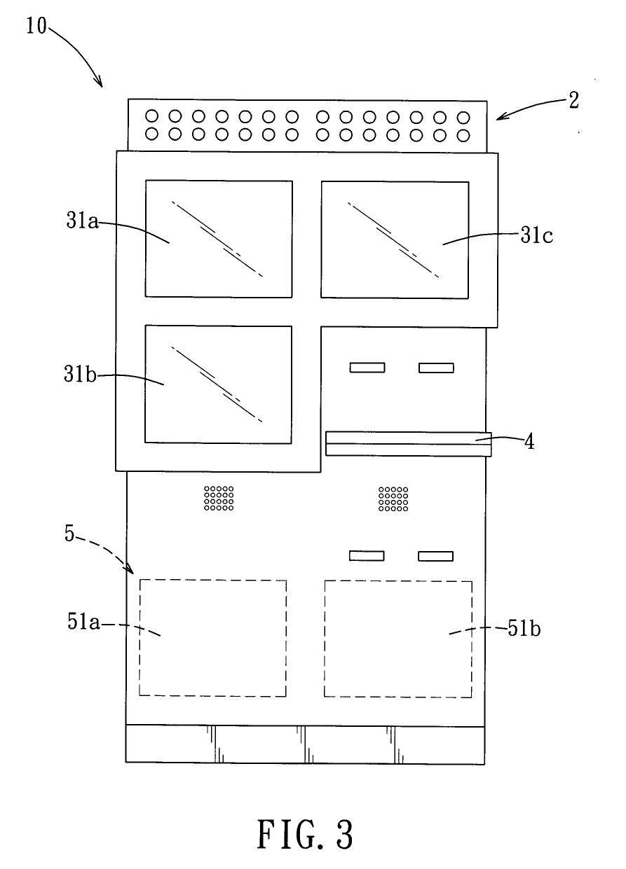

FIGS. 2, 3 and 4 refer to a preferred embodiment of a multi-display gaming machine 10 according to the present invention. The multi-display gaming machine 10 comprises a housing 2, a plurality of display devices 3 mounted to the housing 2, an input device 4 operable for generating control instructions, and a processing device 5 disposed inside the housing 2, coupled to the display devices 3 and the input device 4, and loaded with a plurality of gaming programs. The processing device 5 is responsive to the control instructions from the input device 4 for simultaneously executing at least two of the gaming programs, and for outputting gaming screen contents resulting from execution of the gaming programs to respective ones of the display devices 3 for viewing by a player.

In this embodiment, the housing 2 includes a pentagonal base 21 and a housing body 22. The housing body 22 has a right side portion 222 and a left side portion 221, which are disposed on a pair of adjacent side edge portions of a top side of the base 21 and which extend upwardly therefrom. The left side portion 221 and the right side portion 222 are angled toward each other in accordance with an interior angle formed by the pair of adjacent side edge portions of the base 21.

In this embodiment, three display devices 3 are mounted to the housing 2. The three display devices 3 are identified herein as display device 31a, display device 31b and display device 31c. The display device 31a is mounted to an upper area of the left side portion 221 of the housing body 22. The display device 31b is mounted below the display device 31a on a sloping protrusion 223 formed on the left side portion 221 of the housing body 22. The display device 31c is mounted to an upper area of the right side portion 222 of the housing body 22. The display device 31a and the display device 31c are angled toward each other in accordance with the above described configuration of the right and left side portions 222,221 of the housing body 22. The display device 31b is angled upward toward the display device 31a in accordance with the slope of the sloping protrusion 223.

In this embodiment, the input device 4 is a keyboard disposed below the display device 31c on the right side portion 222 of the housing body 22. Alternatively, the input device 4 could be a mouse, a joystick, or a similar device. In yet another alternative, the input device 4 may include a plurality of touch-control screens provided on the display devices 3, respectively.

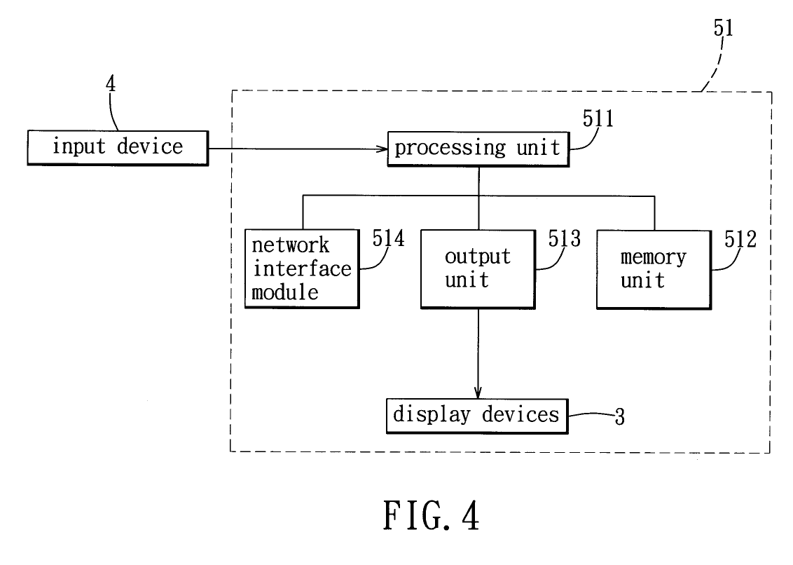

Preferably, the processing device 5 includes a memory unit 512 for storing the gaming programs, a processing unit 511 coupled to the memory unit 512 for executing the gaming programs, and an output unit 513 coupled to and controlled by the processing unit 511 for outputting the gaming screen contents to the respective ones of the display devices 3 (see FIG. 4). Preferably, the processing device 5 further outputs game-related information resulting from execution of the gaming programs to a dedicated one of the display devices 3. Preferably, the processing device 5 is in the form of a motherboard 51. In this embodiment, the processing device 5 includes two motherboards 51 coupled to the display devices 3. The two motherboards 51 are identified herein as motherboard 51a and motherboard 51b. Each of the motherboards 51 is responsive to the control instructions from the input device 4 for executing a corresponding one of the gaming programs. Each motherboard 51 includes a memory unit 512 for storing the corresponding one of the gaming programs, a processing unit 511 coupled to the memory unit 512 for executing the corresponding one of the gaming programs, and an output unit 513 coupled to and controlled by the processing unit 511 for outputting the gaming screen content resulting from execution of the corresponding one of the gaming programs to the respective one of the display devices 3. In this embodiment, the motherboard 51a outputs gaming screen content to the display device 31b, whereas the motherboard 51b outputs gaming screen content to the display device 31c. The player is thus provided an option of playing two different games simultaneously. Each of the motherboards 51 further outputs game-related information, e.g., game scores, resulting from execution of the corresponding one of the gaming programs to the dedicated one of the display devices 3, i.e., the display device 31a, where it can be easily read by the player.

In this embodiment, each of the motherboards 51 further includes a network interface module 514 for connecting the processing unit 511 to a network. The player can thereby connect to the Internet and play online games, and receive announcements and advertisements. In this embodiment, the processing unit 511 of the motherboard 51b drives the output unit 513 to output the announcements and advertisements to the dedicated display device 31a.

It should be apparent to one skilled in the art that the number of display devices 3 and the number of motherboards 51 could be equal or unequal; both options are within the scope of the present invention.

It has thus been shown that the multi-display gaming machine of the present invention displays game-related information in a way that is easy to read, and provides the player the option of playing two different games simultaneously.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A multi-display gaming machine comprising:
a housing;
a plurality of display devices mounted to said housing;
an input device operable for generating control instructions; and
a processing device disposed inside said housing and coupled to said display devices and said input device, said processing device being loaded with a plurality of gaming programs, and being responsive to the control instructions from said input device for simultaneously executing at least two of the gaming programs and for outputting gaming screen contents resulting from execution of the gaming programs to respective ones of said display devices for viewing by a player.

2. The multi-display gaming machine as claimed in claim 1, wherein said processing device includes a memory unit for storing the gaming programs, a processing unit coupled to said memory unit for executing the gaming programs, and an output unit coupled to and controlled by said processing unit for outputting the gaming screen contents to the respective ones of said display devices.

3. The multi-display gaming machine as claimed in claim 2, wherein said processing device is in a form of a motherboard.

4. The multi-display gaming machine as claimed in claim 1, wherein said processing device further outputs game-related information resulting from execution of the gaming programs to a dedicated one of said display devices.

5. The multi-display gaming machine as claimed in claim 1, wherein said input device includes a plurality of touch-control screens provided on said display devices, respectively.

6. The multi-display gaming machine as claimed in claim 1, wherein:
said multi-display gaming machine includes three of said display devices;
said processing device includes two motherboards coupled to said display devices, each of said motherboards being responsive to the control instructions from said input device for executing a corresponding one of the gaming programs, and including
a memory unit for storing the corresponding one of the gaming programs,
a processing unit coupled to said memory unit for executing the corresponding one of the gaming programs, and
an output unit coupled to and controlled by said processing unit for outputting the gaming screen content resulting from execution of the corresponding one of the gaming program to the respective one of said display devices; and
each of said motherboards of said processing device further outputs game-related information resulting from execution of the corresponding one of the gaming programs to a dedicated one of said display devices.

7. The multi-display gaming machine as claimed in claim 6, wherein each of said motherboards further includes a network interface module for connecting said processing unit to a network.
